(19) United States
(12) Patent Application Publication
(10) Pub. No.: US 2014/0072090 A1
(43) Pub. Date: Mar. 13, 2014

(54) METHOD AND SYSTEM FOR AN ALTERNATE RPV ENERGY REMOVAL PATH

(71) Applicants: John R. BASS, Wilmington, NC (US); Robert J. GINSBERG, Wilmington, NC (US)

(72) Inventors: John R. BASS, Wilmington, NC (US); Robert J. GINSBERG, Wilmington, NC (US)

(73) Assignee: GE-HITACHI NUCLEAR ENERGY AMERICAS LLC, Wilmington, NC (US)

(21) Appl. No.: 13/613,281

(22) Filed: Sep. 13, 2012

(51) Int. Cl. G21C 15/00

(52) U.S. Cl. 376/298

(57) ABSTRACT

A method and system for an alternate energy removal path for a reactor pressure vessel (RPV) of a light water reactor. A pair of manually operated containment isolation valves, one located inside and one located outside of primary containment, are used to open and close a steam extraction line that is fluidly coupled between the RPV and a heat sink. The heat sink is located outside of primary containment. A source of external electrical power is not required to operate the system or perform the method.

### BACKGROUND OF THE INVENTION

1. Field of the Invention

Example embodiments relate generally to nuclear reactors, and more particularly to an alternate reactor pressure vessel (RPV) energy removal path. The alternate energy path may provide emergency steam extraction without the use of external electric power.

2. Related Art

FIG. 1 is a cut-away view of a conventional boiling water nuclear reactor (BWR) reactor building 5 (it should be noted that example embodiments may be applied to other light water reactors, other than a BWR, such as a pressurized water reactor, or PWR). The reactor pressure vessel (RPV) 1 is located near the middle of the reactor building 5 and surrounded by a primary containment boundary (the primary containment boundary consisting of portions of a steel primary containment vessel 3, a concrete shell 4 and a steel suppression pool 2). During RPV 1 over-pressurization, safety/relief valves (SRVs) 18 (see FIG. 2) in a SRV steam line 16 may be opened to allow high pressure steam from the RPV 1 to discharge into quenchers 19 located in the suppression pool 2. This may be done to limit RPV 1 pressure, especially in the case of a plant emergency. The suppression pool 2 is an extension of the steel primary containment vessel 3 that may be a torus shaped pool located below the RPV 1. Because the suppression pool 2 contains a large body of water, it may act as a heat sink to cool and condense the steam that is discharged through the quenchers 19.

In addition to the suppression pool 2, a RPV main steam line 12 may also be used to extract large amounts of steam when main steam isolation valves (MSIVs) 13 are opened (though the MSIVs 13 require external electrical power to operate). Conventionally, drain valves 15 for the MSIVs 13 may also be opened (via the use of external electrical power, required to operate the drain valves 15), allowing the drain lines 14 to also discharge high pressure steam from the RPV 1.

### SUMMARY OF INVENTION

Example embodiments provide a method and system for an alternate energy removal path for the reactor pressure vessel (RPV) of a light water reactor. The energy may be removed from the RPV without the use of external electrical power.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a cut-away view of a conventional boiling water nuclear reactor (BWR) reactor building;

FIG. 2 is a one-line diagram of a system, in accordance with an example embodiment;

FIG. 3 is a flowchart of a method of making a system, in accordance with an example embodiment; and

FIG. 4 is a flowchart of a method of using a system, in accordance with an example embodiment.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

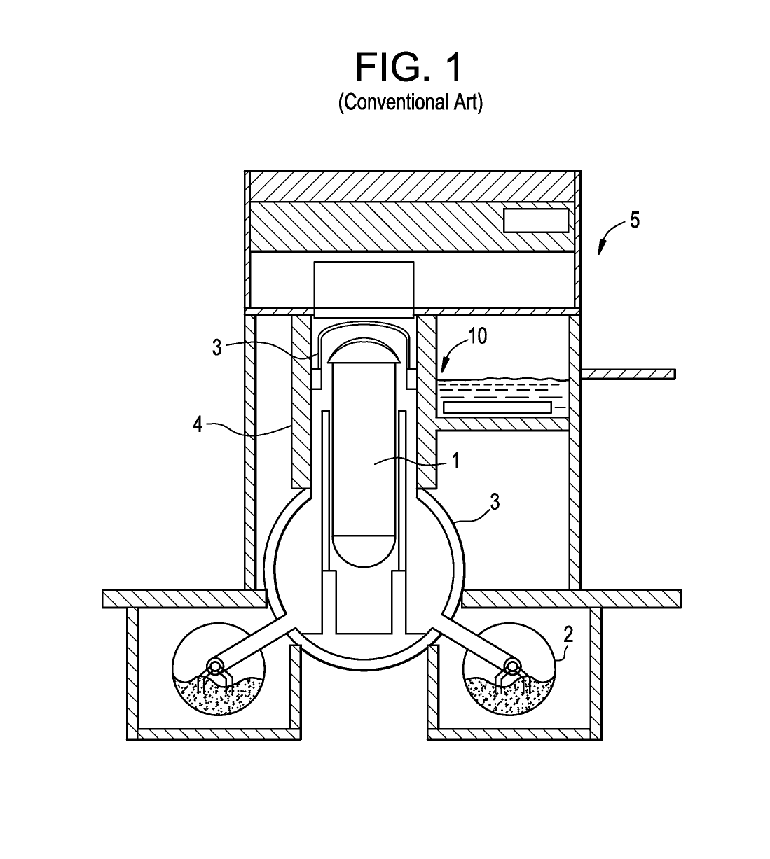

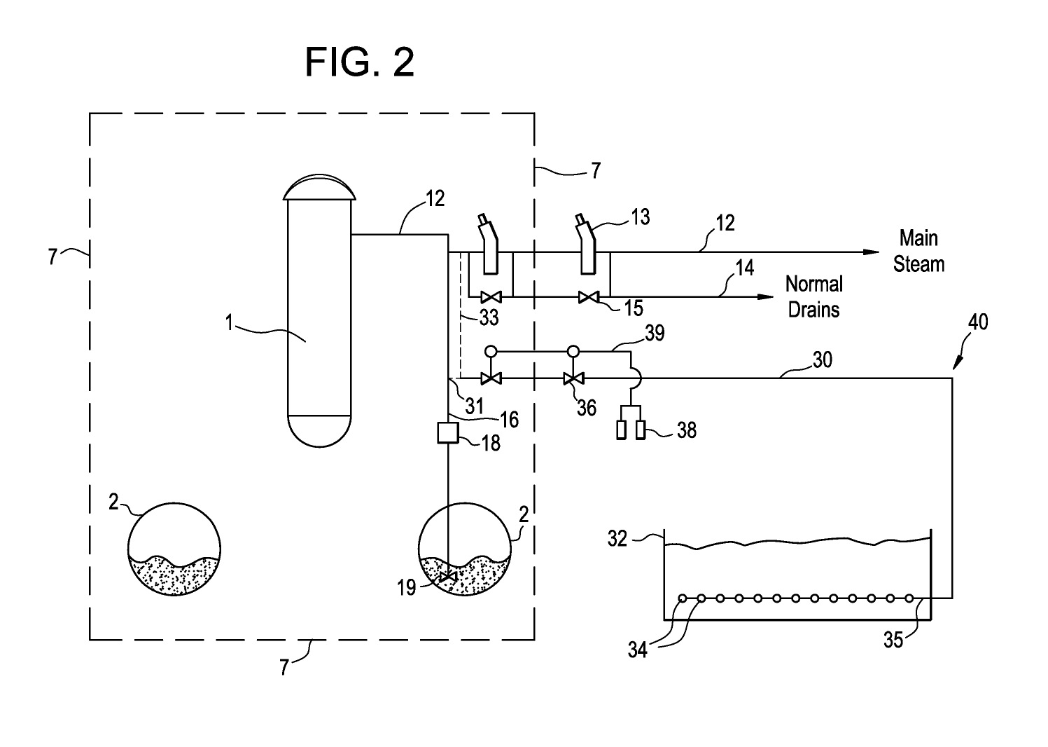

FIG. 2 is a one-line diagram of a system 40, in accordance with an example embodiment. The system 40 may include an alternate reactor pressure vessel (RPV) energy removal line (a steam extraction line) 30 that discharges into a large heat sink (a large body of water), such as the condenser hotwell 32, located outside of the primary containment 7 (the primary containment 7 consisting of portions of a steel primary containment vessel 3, a concrete shell 4 and a steel suppression pool 2, as shown in FIG. 1). In particular, the alternate RPV energy removal line 30 may be connected to a quencher pipe 35 in the condenser hotwell 32, and steam discharging through the quencher pipe 35 may exit pipe 35 via a number of quencher holes 34 (that may be used to effectively dissipate the discharged steam throughout the volume of the condenser hotwell 32). The quencher pipe 35 may be located along the bottom of the condenser hotwell 32, to maximize the heat exchange between the discharging steam (exiting through the quencher holes 34) and the cool water in the condenser hotwell 32. The alternate RPV energy removal line 30 may be a 4 to 6 inch diameter pipe, or another size of pipe that may be large enough to remove the necessary amount of heat from the RPV 1. Having the alternate RPV energy removal line 30 discharge excess steam from the RPV 1 into the condenser hotwell 32 allows the excess steam to be cooled, condensed, and scrubbed of radiation, to safely and effectively reduce excess pressure and heat energy that is located in the RPV 1.

The alternate RPV energy removal line 30 may be connected to either a SRV steam extraction line 31 (connected to the SRV steam line 16, upstream of the SVR valves 18), or a RPV main steam extraction line 33 (connected to the RPV main steam line 12, upstream of the MSIVs 13). Two containment isolation valves 36 (one located inside the primary containment boundary 7, and one located outside of primary containment 7) may be located in the alternate RPV energy removal line 30 piping, in order to open or close the alternate RPV energy removal line 30. A pressurized gas source 38 (such as pressurized gas bottles, or preferably nitrogen bottles) may provide control gas via a pressure control line 39. By locating the gas source 38 in a remote location, relative to the primary containment boundary 7 (and relative to RPV 1), the gas source 38 may be used by plant personnel to remotely operate the manually operated containment isolation valves 36 without exposing personnel to the RPV 1 or primary containment 7 (in the case of a serious plant accident). Because the containment isolation valves 36 may be opened via the force of the pressurized gas source 38, no external electrical power is necessary to operate the system 40 (which is ideal during a plant accident when plant electrical power may be disrupted).

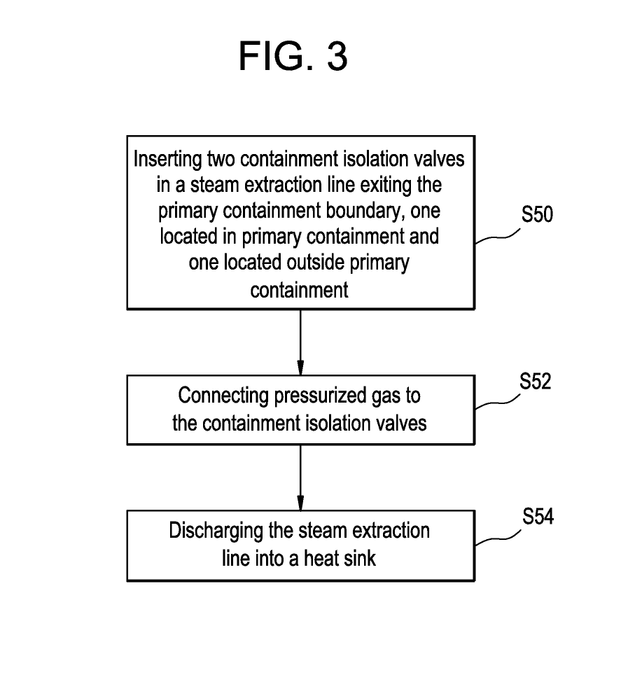

FIG. 3 is a flowchart of a method of making a system 40, in accordance with an example embodiment. In step S50, two manually operated containment isolation valves 36 may be inserted into the alternate RPV energy removal line (steam extraction line) 30. One containment isolation valve 36 may be located in the primary containment 7, and the other may be located outside of the primary containment 7. The alternate RPV energy removal line 30 may discharge excess steam from the RPV 1, as discussed above.

In step S52, a pressurized gas source 38, such as pressurized gas bottles 38, may be connected to the containment isolation valves 36. The gas source 38 may be located in a position that is remotely located from primary containment 7, to ensure the safe operation of the system 40 without personnel exposure to the primary containment 7 (in the event of a serious plant accident).

In step S54, the alternate RPV energy removal line 30 may be connected to a heat sink, such as the condenser hotwell 32, located outside of primary containment 7. The discharge of excess steam from RPV 1 into the condenser hotwell 32 will allow the steam to be cooled, condensed, and scrubbed of radiation, to safely and effectively reduce excess pressure and heat energy that is located in the RPV 1.

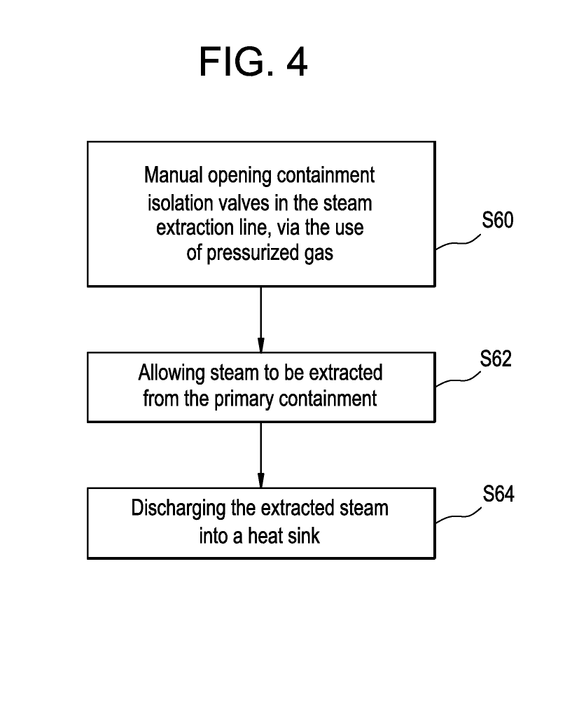

FIG. 4 is a flowchart of a method of using the system 40 shown in FIG. 2, in accordance with an example embodiment. Specifically, step S60 may include manually opening the containment isolation valves 36 in the alternate RPV energy removal line (steam extraction line) 30. This may be accomplished using the pressurized gas source 38 that is connected to the containment isolation valves 36.

In step S62, excess steam may be allowed to exit the RPV 1 and primary containment 7 via the alternate RPV energy removal line 30 (due to the opening of the containment isolation valves 36). In step S64, the extracted steam in the alternate RPV energy removal line 30 may be discharged into the heat sink (such as the condenser hotwell) 32, located outside of primary containment 7. The extracted steam may safely and effectively cooled, condensed, and scrubbed of radiation, by being discharged into the heat sink 32, thereby lowering excess pressure that may have otherwise built up in the RPV 1. No external electric power is required to perform the method shown in FIG. 4.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. An alternate reactor pressure vessel (RPV) energy removal system, comprising:
a steam extraction line, fluidly connected to a RPV and a heat sink, the heat sink being located outside of primary containment; and
a first and a second manually operated containment isolation valve in the steam extraction line, the first containment isolation valve being located within the primary containment, the second containment isolation valve being located outside of the primary containment,
wherein no external electrical power is required to operate the system.

2. The alternate RPV energy removal system of claim 1, further comprising:
at least one pressurized gas source connected to the first and second containment isolation valves via a pressure control line, the at least one pressurized gas source being configured to produce pressurized gas to manually open and close the first and second containment isolation valves.

3. The alternate RPV energy removal system of claim 2, wherein the at least one pressurized gas source is positioned in a location that is remote from the primary containment.

4. The alternate RPV energy removal system of claim 1, wherein the steam extraction line is connected to one of a SRV steam line upstream of safety relief valves and a RPV main steam line upstream of main steam isolation valves.

6. The alternate RPV energy removal system of claim 1, wherein the heat sink is a condenser hotwell.

7. The alternate RPV energy removal system of claim 6, further comprising:
a quencher pipe located along a bottom floor of the hotwell, the quencher pipe being connected to the steam extraction line;
quencher holes located along the quencher pipe.

8. A method of making an alternate reactor pressure vessel (RPV) energy removal system, comprising:
fluidly connecting a steam extraction line to a RPV and a heat sink, the heat sink being located outside of primary containment; and
inserting first and second manually operated containment isolation valves in the steam extraction line, the first containment isolation valve being located within the primary containment, the second containment isolation valve being located outside of the primary containment,
wherein no external electrical power is required to operate the system.

9. The method of claim 8, further comprising:
connecting at least one pressurized gas source to the first and second containment isolation valves via a pressure control line, the at least one pressurized gas source being configured to produce pressurized gas to manually open and close the first and second containment isolation valves.

10. The method of claim 9, further comprising:
positioning the at least one pressurized gas source to be in a location that is remote from the primary containment.

11. The method of claim 8, further comprising:
connecting the steam extraction line to one of a SRV steam line upstream of safety relief valves and a RPV main steam line upstream of main steam isolation valves.

12. The method of claim 8, wherein the heat sink is a condenser hotwell.

13. The method of claim 12, further comprising:
providing a quencher pipe along a bottom floor of the hotwell;
inserting quencher holes along the quencher pipe; and
connecting the steam extraction pipe to the quencher pipe.

14. A method of using the alternate RPV energy removal system of claim 2, comprising:
manually opening the first and second containment isolation valves using the at least one pressurized gas source.

15. The method of claim 14, further comprising:
allowing steam to be discharged from the RPV to the heat sink through the steam extraction line.
